(19) United States
(12) Patent Application Publication
(10) Pub. No.: US 2004/0202110 A1
(43) Pub. Date: Oct. 14, 2004

(54) Method and apparatus for managing sliding window in IP security

(75) Inventor: Young-sup Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/782,855

(22) Filed: Feb. 23, 2004

(30) Foreign Application Priority Data
Mar. 11, 2003 (KR) 2003-15192

(51) Int. Cl. H04L 1/00; G06F 11/00; G08C 15/00; G06F 15/173

(52) U.S. Cl. 370/235; 709/238; 370/389

(57) ABSTRACT

A method and apparatus for managing a sliding window in an IP security algorithm are provided. The method involves (a) determining whether or not a sliding window, used for determining whether or not a received IP packet is to be transmitted or abandoned, is full of IP packets; and (b) updating sequence numbers stored in the sliding window by adding a size of the sliding window to each of the sequence numbers if the sliding window is full of IP packets. Accordingly, a sliding window is updated by adding the size of the sliding window or a predetermined value to each sequence number stored in the sliding window irrespective of a sequence number of a received IP packet. Therefore, IP packets can be more stably transmitted by checking the sequence number of the received IP packet and abandoning the received IP packet if the sequence number of the received IP packet is not within a predetermined range.

### BACKGROUND OF THE INVENTION

This application claims the priority of Korean Patent Application No. 2003-15192, filed Mar. 11, 2003, in the Korean Intellectual Property Office, the disclosure of which is incorporated herein in its entirety by reference.

1. Field of the Invention

The present invention relates to network security applied to Internet protocol (IP) layers, and more particularly, to a method and apparatus for managing a sliding window used in an IP security algorithm.

2. Description of the Related Art

One of the existing transaction security standards in a network level is IP security (IPsec). IPsec guarantees security of IP packet transmission between IP layers and provides security services for all data transmitted from an upper layer to a lower layer. IPsec uses an RFC 2402 IP Authentication Header (AH) and an RFC 2406 IP Encapsulating Security Payload (ESP).

FIG. 1 is a diagram illustrating the format of an IP AH. An IP AH is used for authenticating whether received data has been transmitted from a desired source address and guaranteeing the integrity of the received data by using a hash algorithm, such as MD5 or SHA-1. After checking whether or not the integrity of each IP packet is intact, a sequence number (SN) 110 is allocated to each IP packet, thus preventing replay attacks. In other words, authentication is carried out by adding an AH to an IP header of each IP packet.

FIG. 2 is a diagram illustrating the format of an IP ESP. The IP ESP provides confidentiality and integrity to an IP network. In other words, confidentiality of transmission of an IP packet is guaranteed by encrypting the IP packet. In order to encrypt the IP packet in a manner that guarantees the confidentiality of the transmission of the IP packet, a variety of encryption algorithms, such as DES or 3DES, are used. The IP ESP, like the IP AH, can authenticate a source address of each IP packet and can prevent replay attacks. As shown in FIG. 2, a sequence number 210 is stored in the IP ESP.

The IP AH and the IP ESP use a sliding window. The sliding window is used for preventing replay attacks delivered by an arbitrary attacker.

Management of the sliding window is carried out in three steps as follows:

(1) An IP packet is received, a sequence number included in the IP packet is read, and it is checked whether the read sequence number is between rightmost and leftmost values of the sliding window. If the read sequence number is not between the rightmost and leftmost values of the sliding window, the IP packet is abandoned, which is called an anti-replay service.

(2) A source address of a sender is checked based on the read sequence number. In other words, it is checked whether the IP packet has been transmitted from a desired sender rather than an attacker.

(3) By using the read sequence number of the IP packet, the sliding window where the sequence number is stored is updated. A method of updating the sliding window is as follows.

FIG. 3 is a diagram illustrating a method of updating a sliding window. If the sliding window has a size of 32 and 32 IP packets are received, a sequence number 310 stored in the far left of the sliding window is 1, and a sequence number 320 stored in the far right of the sliding window is 32. If another IP packet is received, the sliding window is full of IP packets because 32 IP packets have already been received. Therefore, the sliding window is updated by referring to sequence numbers included in the newly received IP packet.

In other words, a sequence number included in the 33^{rd} IP packet is stored in the sliding window. During this process, if an attacker transmits an IP packet having a very large sequence number, the sliding window is updated based on the sequence number of the IP packet sent by the attacker. Then, even though a desired IP packet is received, the desired IP packet is abandoned because a sequence number included in the desired IP packet is smaller than a sequence number included in the updated sliding window.

More specifically, if the sliding window where the sequence number 310 is stored in the far left and the sequence number 320 is stored in the far right is full of IP packets and an attacker transmits an IP packet having a sequence number of 100, the sliding window is updated into a sliding window where 69 is stored in the far left and 100 is stored in the far right. Therefore, if an IP packet having a sequence number between 33 and 68 is received after the updating of the sliding window, the IP packet is abandoned. Accordingly, even though it can protect an IP network from replay attacks, the above method of managing a sliding window is very vulnerable to attacks against the IP network delivered by an attacker transmitting an IP packet having a very large sequence number.

### SUMMARY OF THE INVENTION

Accordingly, the invention provides a method and apparatus for managing a sliding window which can check whether the integrity of received IP packets is intact, can prevent replay attacks, and can effectively use memory.

According to an aspect of the present invention, there is provided a method of managing a sliding window. The method involves (a) determining whether or not a sliding window, used for determining whether or not a received IP packet is to be transmitted or abandoned, is full of IP packets; and (b) updating sequence numbers stored in the sliding window by adding a size of the sliding window to each of the sequence numbers if the sliding window is full of IP packets.

According to another aspect of the present invention, there is provided a method of managing a sliding window. The method involves (a) determining whether or not a sliding window, used for determining whether or not a received IP packet is to be transmitted or abandoned, is full of IP packets; and (b) updating sequence numbers stored in the sliding window by adding a predetermined constant to each of the sequence numbers if the sliding window is full of IP packets.

According to another aspect of the present invention, there is provided a method of managing a sliding window. The method involves (a) setting the size and sequence number information of a sliding window; (b) receiving an IP packet and reading a sequence number included in the received IP packet; (c) determining whether or not the sequence number of the received IP packet is within a range of sequence numbers of the sliding window set in (a); (d) if the sequence number of the received IP packet is within the range of the sequence numbers of the sliding window, transmitting the received IP packet to a following network layer and otherwise, abandoning the received IP packet; (e) determining whether or not the sliding window is full of IP packets; and (f) updating the sliding window if the sliding window is full of IP packets.

According to another aspect of the present invention, there is provided an apparatus for managing a sliding window. The apparatus includes a sequence number information reading unit which receives an IP packet and reads a sequence number included in the received IP packet; memory which stores sequence number information of a sliding window; and a comparison unit which compares the sequence number read by the sequence number information reading unit with the sequence number information of the sliding window, transmits the received IP packet to a following layer if the sequence number read by the sequence number information reading unit is within a range of sequence numbers stored in the sliding window, abandoning the received IP packet otherwise, determining whether or not the sliding window is full of IP packets, and updating the sliding window if the sliding window is full of IP packets.

According to another aspect of the present invention, there is provided a computer-readable recording medium on which a program enabling one of the above-described methods of managing a sliding window is recorded.

### BRIEF DESCRIPTION OF THE DRAWINGS

The above features and advantages of the present invention will become more apparent by describing in detail exemplary embodiments thereof with reference to the attached drawings in which:

FIG. 1 is a diagram illustrating the format of an IP authentication header (AH);

FIG. 2 is a diagram illustrating the format of an IP encapsulating security payload (ESP);

FIG. 3 is a diagram illustrating a conventional method of updating a sliding window;

FIG. 4 is a diagram illustrating a method of updating a sliding window according to an embodiment of the present invention;

FIG. 5 is a flowchart of a method of statically updating a sliding window according to an embodiment of the present invention; and

FIG. 6 is a block diagram of an apparatus for updating a sliding window according to an embodiment of the present invention.

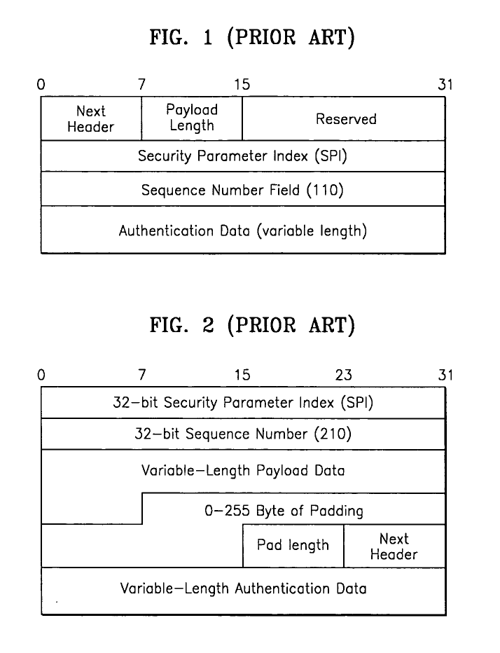

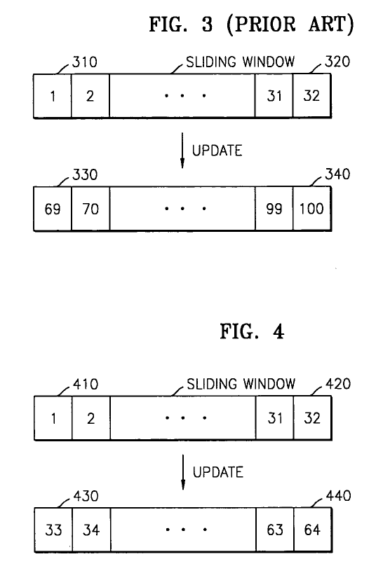

### DETAILED DESCRIPTION OF THE INVENTION

Hereinafter, the present invention will be described in greater detail with reference to the accompanying drawings in which various embodiments of the invention are shown.

FIG. 4 is a diagram illustrating a method of updating a sliding window according to an embodiment of the present invention. Two different methods of updating a sliding window when the sliding window is full of IP packets will be described in the following paragraphs with reference to FIG. 4.

When a sliding window is full of IP packets, it could be updated in a static manner, which is a first method. For example, if leftmost and rightmost values of a sliding window are 1 (410) and 32 (420), respectively, and the sliding window is full of IP packets, as shown in FIG. 4, sequence numbers stored in the sliding window are respectively increased by as much as the size of the window, i.e., 32, irrespective of a sequence number of a newly received IP packet. Accordingly, the leftmost and rightmost values of the sliding window are updated from 1 (310) and 32 (420), respectively, to 33 (430) and 64 (440), respectively.

Alternatively, the sequence numbers stored in the sliding window could be respectively increased by as much as a predetermined value rather than the size of the sliding window, which is a second method. For example, when the size of the sliding window is 32, the leftmost and rightmost values of the sliding window are 1 and 32, respectively, and the sliding window is full of IP packets, the sliding window can be updated by respectively increasing the sequence numbers stored in the sliding window by as much as ‘m’ so that the leftmost and rightmost values of the sliding window are updated to 33−m and 33+m, respectively.

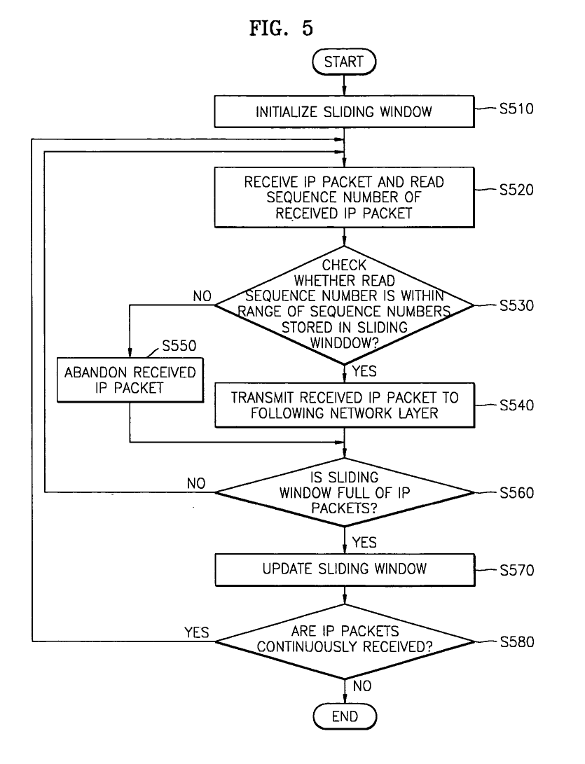

FIG. 5 is a flowchart of a method of statically updating a sliding window according to an embodiment of the present invention. Referring to FIG. 5, a sliding window is initialized in step S510. In the initialization of the sliding window, leftmost and rightmost values of the sliding window are set to 0 and 1 the size of the sliding window −1′, respectively, and the size of the sliding window is set to ‘n’. In the case of adopting the above second method, a process of setting how much the sequence numbers of the sliding window are to be increased to ‘m’ is additionally carried out.

In step S520, an IP packet is received, and a sequence number of the received IP packet is read. In step S530, it is determined whether or not the read sequence number is between the leftmost and rightmost values of the sliding window. If the read sequence is between the leftmost and rightmost values of the sliding window, the IP packet is transmitted to a following network layer, such as a TCP layer, in step S540. Otherwise, the IP packet is abandoned in step S550. If the sliding window is full of IP packets (S560), it is updated using either the first or second method in step S570. Otherwise, the method returns to step S520. After the updating of the sliding window, it is checked in step S580 whether or not IP packets are continuously received. If IP packets are continuously received, the method returns to step S520 and steps S520 through S580 are repeatedly carried out. Otherwise, the whole process is completed. The above-mentioned sequence numbers can be used in a variety of security algorithms as well as an AH and an ESP.

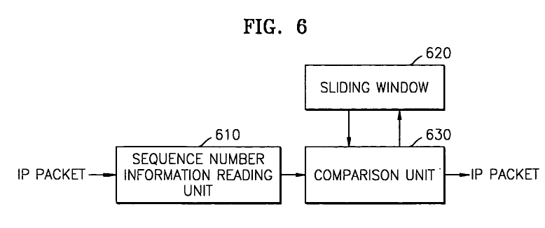

FIG. 6 is a block diagram of an apparatus for updating a sliding window according to an embodiment of the present invention. Referring to FIG. 6, the apparatus includes a sequence number information reading unit 610, a sliding window 620, and a comparison unit 630.

The sequence number information reading unit 610 receives an IP packet and reads a sequence number (SN) included in a header of the received IP packet. The sliding window 620 is a sort of memory for storing sequence number information to filter the received IP packet.

The comparison unit 630 compares the sequence number read by the sequence number information reading unit 610 with sequence numbers stored in the sliding window 620. If the read sequence number is within a range of the sequence numbers of the sliding window 620, the received IP packet is transmitted to a following network layer. Otherwise, the received IP packet is abandoned. The comparison unit 630 determines whether or not the sliding window 620 is full of IP packets. If the sliding window is full of IP packets, the comparison unit 630 updates the sliding window 620. The sliding window 620 could be updated in a static manner or by as much as a predetermined size, which has already been described above with reference to FIG. 5.

The present invention can be realized as computer-readable codes stored on a computer-readable recording medium. The computer-readable recording medium includes all kinds of recording devices on which data can be stored in a computer-readable manner. For example, the computer-readable recording medium includes ROM, RAM, CD-ROM, a magnetic tape, a floppy disk, an optical data storage, and a carrier wave (such as data transmission through the Internet). In addition, the computer-readable recording medium can be distributed over a plurality of computer systems connected to a network, and computer-readable codes can be stored on, and executed from, the computer-readable recording medium in a decentralized manner.

As described above, the method and apparatus for managing a sliding window according to the present invention can provide the following advantages.

First, IP packets can be more stably transmitted between network layers by updating a sliding window by as much as a predetermined size of the sliding window irrespective of a sequence number included in an IP packet received after the sliding window is full of IP packets.

Second, memory can be more effectively managed by statically updating the sliding window by as much as a predetermined size of the sliding window.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of managing a sliding window, comprising:
(a) determining whether or not a sliding window, used for determining whether or not a received IP packet is to be transmitted or abandoned, is full of IP packets; and
(b) updating sequence numbers stored in the sliding window by adding a size of the sliding window or predetermined amount to each of the sequence numbers if the sliding window is full of IP packets.

2. A method of managing a sliding window, comprising:
(a) setting the size and sequence number information of a sliding window;
(b) receiving an IP packet and reading a sequence number included in the received IP packet;
(c) determining whether or not the sequence number of the received IP packet is within a range of sequence numbers of the sliding window set in (a);
(d) if the sequence number of the received IP packet is within the range of the sequence numbers of the sliding window, transmitting the received IP packet to a specified network layer and otherwise, abandoning the received IP packet;
(e) determining whether or not the sliding window is full of IP packets; and
(f) updating the sliding window if the sliding window is full of IP packets.

3. The method of claim 2, wherein in (a), leftmost and rightmost values of the sliding window are set to 0 and 1, respectively, and the size of the sliding window is set to n.

4. The method of claim 3, wherein if the sliding window is full of IP packets in (f), the sliding window is updated by adding a size of the sliding window set in (a) to each of the sequence numbers stored in the sliding window.

5. The method of claim 2, wherein in (a), leftmost and rightmost values of the sliding window are set to 0 and 1, respectively, the size of the sliding window is set to n, and the extent to which each of the sequence numbers stored in the sliding window is to be increased is set to m.

6. The method of claim 5, wherein if the sliding window is full of IP packets in (f), the sliding window is updated by adding m to each of the sequence numbers stored in the sliding window.

7. An apparatus for managing a sliding window, comprising:
a sequence number information reading unit operable to receive an IP packet and read a sequence number included in the received IP packet;
memory operable to store sequence number information of a sliding window; and
a comparison unit operable to compare the sequence number read by the sequence number information reading unit with the sequence number information of the sliding window, transmit the received IP packet to a specified network layer if the sequence number read by the sequence number information reading unit is within a range of sequence numbers stored in the sliding window, abandon the received IP packet otherwise, determine whether or not the sliding window is full of IP packets, and update the sliding window if the sliding window is full of IP packets.

8. The apparatus of claim 7, wherein the comparison unit is operable to update the sliding window by adding a size of the sliding window or a predetermined value to each of the sequence numbers stored in the sliding window.

9. A computer-readable recording medium on which a program enabling a method of managing a sliding window is recorded, the method of managing a sliding window comprising:
(a) determining whether or not a sliding window, used for determining whether or not a received IP packet is to be transmitted or abandoned, is full of IP packets; and
(b) updating sequence numbers stored in the sliding window by adding a size of the sliding window to each of the sequence numbers if the sliding window is full of IP packets.
